(19) United States
(12) Patent Application Publication
(10) Pub. No.: US 2017/0206746 A1
(43) Pub. Date: Jul. 20, 2017

(54) CARD GAME

(71) Applicant: Mark W. Sanders, Tamworth (GB)

(72) Inventor: Mark W. Sanders, Tamworth (GB)

(21) Appl. No.: 15/404,289

(22) Filed: Jan. 12, 2017

(30) Foreign Application Priority Data
Jan. 14, 2016 (GB) 1600720.5

(51) Int. Cl. G07F 17/32; A63F 1/06; A63F 1/00

(52) U.S. Cl. CPC G07F 17/3293; A63F 1/00; A63F 1/067; G07F 17/3288; G07F 17/3209; A63F 2001/005

(57) ABSTRACT

An apparatus for playing a card game, the apparatus including a plurality of playing cards and a gaming table 2, the gaming table 2 including a community area 12, a dealer area 10 and a player area 14.

Embodiments of the present invention relate to a card game, and in particular a card game suitable for use in a casino.

Card games are routinely played in casinos where players can place bets on the outcome of the game. There is a need for a new card game that has mathematically determined odds to ensure that the casino has at all times an overall advantage over the players whilst at the same time ensuring that the players have a reasonable chance of winning to encourage repeat play.

According to a first aspect of the present invention there is provided a method of playing a card game including a plurality of playing cards and a gaming table, the gaming table including a dealer area, a community area, and a player area, the method including:
a) a player making a first bet,
b) the dealer dealing three cards to the player and three cards to the dealer;
c) the dealer dealing out a first set of cards face-up on the community area,
d) the player optionally making a second bet,
e) the dealer dealing out a second set of cards face-up on the community area,
f) the player optionally making a third bet,
g) the dealer dealing out a third set of cards face-up on the community area,
h) the dealer's cards being placed face-up on the dealer area,
i) the player's cards being placed face-up on the player area.

The community area may be defined by a plurality of card receiving spaces.

The card receiving spaces may be arranged in columns, and may be arranged in four columns, namely the first column, second column, third column and fourth column.

Preferably, the first column includes three card receiving spaces, the second column includes three card receiving spaces, the third column includes two card receiving spaces, and the fourth column includes two card receiving spaces.

Preferably, the first column includes first, second and third card receiving spaces, the second column includes first, second and third card receiving spaces, the third column includes first and second card receiving spaces, and the fourth column includes first and second card receiving spaces.

Preferably, the first set of cards includes five cards, the second set of cards includes three cards, and the third set of cards includes two cards.

Preferably, a first card of the first set of cards is dealt to the first card receiving space of the first column, a second card is dealt to the second card receiving space of the first column, a third card is dealt to the third card receiving space of the first column, a fourth card is dealt to the second card receiving space of the second column and a fifth card is dealt to the third card receiving space of the second column.

Preferably, a first card of the second set of cards is dealt to the first card receiving space of the second column, a second card is dealt to the first card receiving space of the third column, and a third card is dealt to the second card receiving space of the third column.

Preferably, a first card of the third set of cards is dealt to the first card receiving space of the fourth column, and a second card is dealt to the second card receiving space of the fourth column.

The dealer area may be defined by a plurality of card receiving spaces arranged in a single column, and there may be three card receiving spaces. The card receiving spaces in the dealer area may be aligned with the card receiving spaces in the community area.

Each of the three dealer's cards may be respectively placed face-up in a one of the card receiving spaces in the dealer area.

The player area may be defined by a plurality of card receiving spaces arranged in a single column, and there may be three card receiving spaces. The card receiving spaces in the player area may be aligned with the card receiving spaces in the community area.

Each of the player's three cards may be respectively placed face-up in a one of the card receiving spaces in the player area.

There may be a plurality of players, and preferably there may be 5 to 13 players, and most preferably there may be 7 players.

The method may include a 52 card deck of playing cards.

According to a second aspect of the present invention there is provided an apparatus for playing a card game including a plurality of playing cards and a gaming table, the gaming table including a community area, a dealer area and a player area.

The community area may be defined by a plurality of card receiving spaces.

The card receiving spaces may be arranged in columns, and may be arranged in four columns, namely the first column, second column, third column and fourth column.

Preferably, the first column includes three card receiving spaces, the second column includes three card receiving spaces, the third column includes two card receiving spaces, and the fourth column includes two card receiving spaces.

Preferably, the first column includes first, second and third card receiving spaces, the second column includes first, second and third card receiving spaces, the third column includes first and second card receiving spaces, and the fourth column includes first and second card receiving spaces.

The dealer area may be defined by a plurality of card receiving spaces arranged in a single column, and there may be three card receiving spaces. The card receiving spaces in the dealer area may be aligned with the card receiving spaces in the community area.

The player area may be defined by a plurality of card receiving spaces arranged in a single column, and there may be three card receiving spaces. The card receiving spaces in the player area may be aligned with the card receiving spaces in the community area.

The gaming table may include at least one player zone suitable for locating the player's cards and bets.

There may be a plurality of player zones, and preferably there may be 5 to 13 player zones, and most preferably there may be 7 player zones.

The gaming table may have one or more sides, which may be straight or convexly curved. The gaming table may have four sides, one of which is convexly curved and three of which are straight.

The player zones may be spaced around one side of the table, or may be spaced around two sides of the table, or may be spaced around three sides of the table. The player zones may be spaced around the convexly curved side of the gaming table.

The community, dealer and player areas may be located substantially centrally on the gaming table.

The apparatus may include a 52 card deck of playing cards.

According to a third aspect of the present invention there is provided an apparatus including: at least one processor; and at least one memory including computer program code configured to, with the at least one processor, cause the apparatus at least to perform a method according to any one or more of the preceding paragraphs.

According to a fourth aspect of the present invention there is provided a computer program that, when run on a computer, performs a method according to any one or more of the preceding paragraphs.

An embodiment of the present invention will now be described by way of example only and with reference to the accompanying drawings, in which:

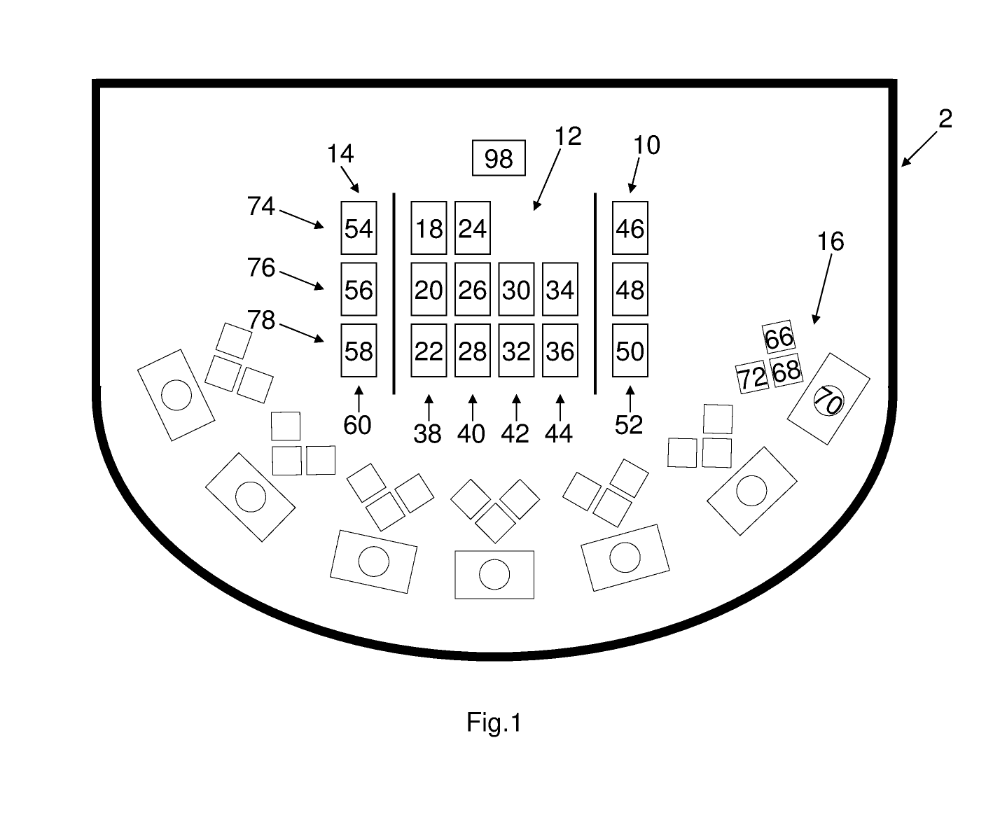

FIG. 1 is a plan view of a gaming table according to the invention;

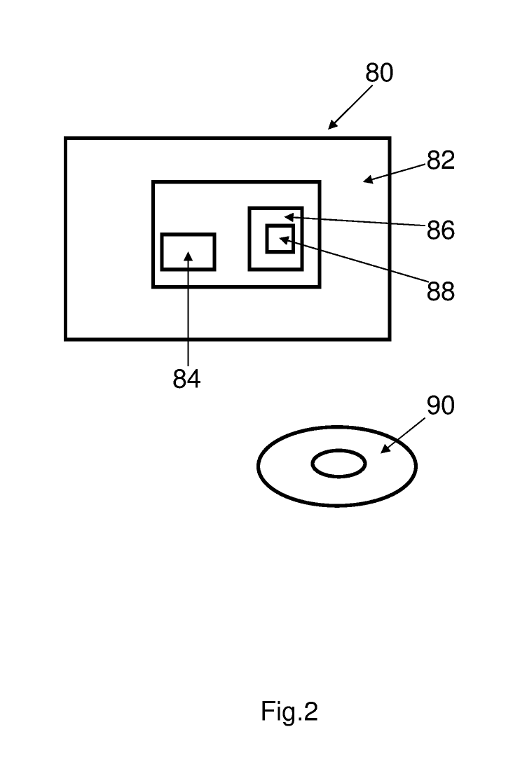

FIG. 2 is an apparatus for carrying out a method according to the invention; and

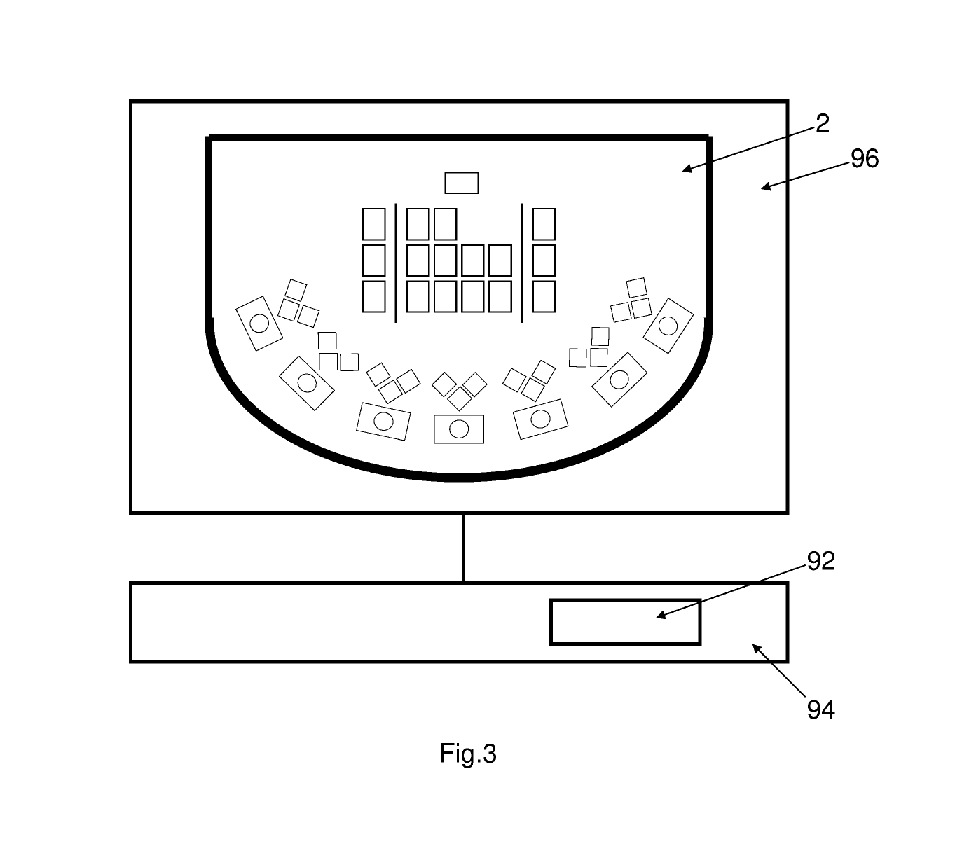

FIG. 3 is a further apparatus for carrying out a method according to the invention.

FIG. 1 shows a gaming table 2 on which a card game is played, which may be an image of a gaming table 2 on a computer screen 96 as shown in FIG. 3. The gaming table 2 includes a dealer area 10, a community area 12, and a player area 14. In the example shown, the gaming table 2 includes seven player zones 16, although a different number could be provided.

The gaming table 2 has four sides, one of which is convexly curved and three of which are straight. The player zones 16 are spaced around the convexly curved side of the gaming table 2. The community area 12, dealer area 10 and player area 14 are located substantially centrally on the gaming table 2.

The community area 12 is defined by a plurality of card receiving spaces 18, 20, 22, 24, 26, 28, 30, 32, 34 and 36, which are arranged in four columns 38, 40, 42 and 44.

The first column 38 includes first, second and third card receiving spaces 18, 20 and 22, the second column 40 includes first, second and third card receiving spaces 24, 26 and 28, the third column 42 includes first and second card receiving spaces 30 and 32, and the fourth column 44 includes first and second card receiving spaces 34 and 36.

The dealer area 10 is defined by a plurality of card receiving spaces 46, 48 and 50 arranged in a single column 52. The card receiving space 46 in the dealer area 10 is aligned with the card receiving spaces 18 and 24 in the community area 12. The card receiving space 48 in the dealer area 10 is aligned with the card receiving spaces 20, 26, 30 and 34 in the community area 12. The card receiving space 50 in the dealer area 10 is aligned with the card receiving spaces 22, 28, 32 and 36 in the community area 12.

The player area 14 is defined by a plurality of card receiving spaces 54, 56 and 58 arranged in a single column 60. The card receiving space 54 in the player area 14 is aligned with the card receiving spaces 18 and 24 in the community area 12. The card receiving space 56 in the player area 14 is aligned with the card receiving spaces 20, 26, 30 and 34 in the community area 12. The card receiving space 58 in the player area 14 is aligned with the card receiving spaces 22, 28, 32 and 36 in the community area 12.

Each player zone 16 includes an area 66 for the player's first “ante” bet, an area 68 for the players second bet, an area 70 for the players third bet, and a area 72 for the player's side bet or bets, as described below.

The areas 66, 68, 70 and 72 of the player zone 16 of the table 2 shown in FIG. 1 have a multitude of layout permutations.

A dealer zone 98 is also provided for locating the dealer's cards.

The method of playing the game will now be described. Before the cards are dealt the player must provide a first bet, known as an “ante” bet, to play the game. The ante bet is also a bet on the front row, as detailed below. The player also has the option to place a side bet or bets, for instance, a 2's Up side bet as detailed below. Multiple side bets can therefore be placed if required, but such side bets are entirely optional. Once all bets are placed the dealer will deal the players' cards.

A total of three cards will be dealt face-down to each player following which the dealer will deal three cards face-down to the dealer. In one example, the cards are dealt from a 52 card deck of playing cards. The dealer's cards are placed face-down in the dealer zone 98. The cards could be dealt by the dealer with a single card being dealt successively to each player in turn until each player has three cards. Alternatively, the cards could be dealt by way of a shuffle machine, as would be understood by a person skilled in the art, such that each player in turn is dealt three cards.

With reference to FIG. 1, the dealer then deals out a first set of five cards face-up on the community area, placing the first card in the first card receiving space 18 of the first column 38, the second card in the second card receiving space 20 of the first column 38, the third card in the third card receiving space 22 of the first column 38, the fourth card in the second card receiving space 26 of the second column 40 and the fifth card in the third card receiving space 28 of the second column 40.

The players now have the option to place a second bet on the middle row, as detailed below. The second bet may be equal to, less than or greater than the ante bet.

The dealer now deals the next set of three cards face-up on the community area 12, placing the first card in the first card receiving space 24 of the second column 40, the second card in the first card receiving space 30 of the third column 42, and the third card in the second card receiving space 32 of the third column 42.

The players now have the option to place a third bet on the back row, as detailed below. The third bet may be equal to, less than or greater than the ante bet.

The dealer now deals the final set of two cards face-up on the community area 12, placing the first card in the first card receiving space 34 of the fourth column 44, and the second card in the second card receiving space 36 of the fourth column 44.

The dealer now positions the dealer's three cards face up on the dealer area, placing a first card in the first card receiving space 46, a second card in the second card receiving space 48, and a third card in the third card receiving space 50 in an order which makes the best possible “open” Chinese Poker hand, as detailed below.

If the dealer has an “open” hand the cards remain face up, if the dealer cannot make an open hand then the dealer's cards are turned face down to indicate a “fouled” hand.

The dealer now positions, in turn, each respective player's three cards face-up on the player area, placing a first card in the first card receiving space 54, a second card in the second card receiving space 56, and a third card in the third card receiving space 58 in an order which makes the best possible “open” Chinese Poker hand, as detailed below.

If the player has an open hand and the dealer has an open hand, the player wins on the front row at odds specified on the bet placed in space 66. If a bet has been placed on the middle row and/or back row, the player wins on the middle row and/or back row at the odds specified on the bet placed respectively in spaces 68 and 70. Tables 1 and 2 below provide an illustrative example of the odds associated with a particular hand using standard Poker hand rakings.

If the dealer has a fouled hand, and the player has an open hand, the player receives back all bets placed. The dealer's cards are placed face down on the dealer area. Optionally, a player may receive 1 to 1 on the ante bet placed in space 66, the player also receiving back all bets placed.

If the dealer has an open hand and the player has a fouled hand, the player loses all bets placed in spaces 66, 68 and 70.

If the dealer and player have fouled hands, the first bet placed in space 66 is lost, and any bets on the middle and back rows placed in spaces 68 and 70 respectively are returned to the player. The dealer's cards are placed face down on the dealer area.

Any sides bets placed are paid irrespective of whether the player and or dealer have open or fouled hands.

### How to Win

The claimed casino game is based on Chinese Poker, as would be understood by a person skilled in the art. For a player to win the game both the player and the dealer must at the end of the game as detailed above provide an “open” Chinese Poker hand.

With reference to FIG. 1, an “open” hand is as follows. The cards in the back row 78 must provide a stronger hand than the hand provided by the cards in the middle row 76, and the cards in the middle row 76 must provide a stronger hand than the hand provided by the cards in the front row 74. The cards which make up the respective front, middle and back rows are different for the dealer and the player, as discussed below.

The strength of a hand is determined by standard Poker hand rakings, as would be understood by a person skilled in the art.

With respect to the dealer, the front row 74 is defined by the cards in the card receiving spaces 18, 24 and 46, and with respect to the player the front row is defined by the cards in the card receiving spaces 54, 18 and 24.

With respect to the dealer the middle row 76 is defined by the cards in the card receiving spaces 20, 26, 30, 34 and 48, and with respect to the player the middle row is defined by the cards in the card receiving spaces 56, 20, 26, 30 and 34.

With respect to the dealer the back row 78 is defined by the cards in the card receiving spaces 22, 28, 32, 36 and 50, and with respect to the player the back row is defined by the cards in the card receiving spaces 58, 22, 28, 32 and 36.

In determining the relative strength of the hands, as in Chinese Poker the back row hand 78 must be stronger than or equal to the middle row hand 76 and the middle row hand 76 must be stronger than or equal to the front row hand 74. The strength of the hand is determined by poker hand rankings. The middle row 76 and back row 78 can make the best five-card poker hand while the front row hand 74 can only make the best three-card hand.

The amount won by a player is dependent on whether bets have been placed on the middle and back rows, in addition to the automatic ante bet on the front row, the amount bet on the respective rows, and the odds associated with a particular hand. Tables 1 and 2 below provide an illustrative example of the odds associated with a particular hand using standard Poker hand rankings.

TABLE 1
Front Row

| Hand | Odds |
|---|---|
| Pair | 1 to 1 |
| Three of a kind | 250 to 1 |

TABLE 2
Middle and Back Rows

| Hand | Middle Row Odds | Back Row Odds |
|---|---|---|
| One Pair | 1 to 1 | 1 to 1 |
| Two pairs | 15 to 1 | 2 to 1 |
| Three of a kind | 35 to 1 | 4 to 1 |
| Straight | 60 to 1 | 10 to 1 |
| Flush | 125 to 1 | 15 to 1 |
| Full house | 250 to 1 | 20 to 1 |
| Four of a kind | 500 to 1 | 60 to 1 |
| Straight flush | 500 to 1 | 250 to 1 |
| Royal flush | 500 to 1 | 500 to 1 |

### 2's Up Side Bet

A 2's Up side bet is an optional bet placed at the same time as the ante bet and before the cards are dealt. A 2's Up side bet is a bet on the hand which can be made from the three cards dealt to the player. A 2's Up side bet is paid irrespective of whether the player and/or dealer have an open hand.

It would be understood by a person skilled in the art that a 2's Up side bet is one example of a side bet. It is envisaged that other types of side bet could be placed, and that multiple different side bets could be placed.

If a 2's Up side bet is made a payout will be made, for example, on the basis of the odds provided in Table 3 below, which are provided for illustration only.

TABLE 3
2's Up side bet

| Hand | Odds |
|---|---|
| Straight flush | 40 to 1 |
| Three of a kind | 30 to 1 |
| Straight | 6 to 1 |
| Flush | 3 to 1 |
| Pair | 1 to 1 |

### Additional Bets

The game also encompasses the following additional bonus payouts, namely the Ante Scoop Bonus and Middle Row Bonus, which provide the player with further opportunities to win. The player must have placed an Ante bet to be eligible for the additional bets.

### Ante Scoop Bonus

If the player has one pair of 2's (22) through to one pair J's (JJ) in the front row hand and an open hand the player wins the Scoop bonus at the declared odds, which could be odds of 2 to 1. The player will win the Ante Scoop Bonus if the dealer has an open hand or if the dealer has not made an open hand.

This is a free bet and is paid against the player's ante bet.

If the player has one pair of Q's (QQ) Queens or better in the front row hand and an open hand the player wins the Scoop bonus at the declared odds, which could be odds of 10 to 1. The player will win the Ante Scoop Bonus if the dealer has an open hand or if the dealer has not made an open hand.

This is a free bet and is paid against the player's ante bet.

### Middle Row Bonus

If the player can make a straight flush or royal flush using the 4 community cards in the middle row 76, defined by spaces 20, 26, 30 and 34 and only 1 of the player cards the player will win the Middle Row Bonus at the declared odds, which could be odds of 25 to 1 for a straight flush or odds of 50 to 1 for a royal flush. The player will win the Middle Row Bonus if the dealer has an open hand or if the dealer has not made an open hand. The player does not need to have an open hand to win the Middle Row Bonus.

This is a free bet and is paid against the player's ante bet.

FIG. 2 shows an apparatus 80 embodying the present invention. The apparatus 80 includes a control means 82 in the form of a controller 82. In the present embodiment the controller 82 includes a processor 84 and storage means 86 for storing data as well as program code 88 for causing the processor 84 to perform the method of playing the card game according to the present invention. The program code 88 may be delivered to the storage means 86 via a non-transient computer readable medium 90 containing the program code 88. The storage means 86 may comprise a memory device 86. The processor 84 and memory device 86 may be formed as a single component or separate components. Only one processor 84 and one memory device 86 are shown in this example, but it will be appreciated that the controller 82 may include several processors 84 and several memory devices 86.

FIG. 3 shows a computer program 92, which when run on a computer 94, performs the method of playing the card game according to the present invention. An image of the gaming table 2 is shown on a computer screen 96.

It is envisaged that a card game according to the present invention could be played, for example, on a standalone computer system such as a lap top computer, a tablet, a mobile/cell phone, a games console, a desk top computer, or online through any of these systems. It is also envisaged that a card game according to the present invention could be played on any electronic gaming machine or device, for example, on a slot machine, and particularly a slot machine of the type commonly found in casinos as would be known to a person skilled in the art.

There is thus described a card game with a number of advantages. The card game provides multiple opportunities for a player to win, and thus encourages repeat play. The card game has mathematically determined odds to ensure that the casino has at all times an overall advantage over the players whilst at the same time ensuring that the players have a reasonable chance of winning to encourage repeat play. The gaming table is arranged to clearly show the games' status such that all the required information is visible to the players, the dealer, the Pit Boss and the security cameras. The additional bonus payouts, namely the Ante Scoop Bonus and Middle Row Bonus are free bets which provide additional chances to win. Accordingly, repeat play is encouraged.

Although embodiments of the present invention have been described in the preceding paragraphs with reference to various examples, it should be appreciated that modifications to the examples given can be made without departing from the scope of the invention as claimed.

For example, the payout odds may be modified, or a different number of cards may be dealt to the community area.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for playing a card game including a plurality of playing cards and a gaming table, the gaming table including a community area, a dealer area and a player area.

2. An apparatus according to claim 1, in which the community area is defined by a plurality of card receiving spaces.

3. An apparatus according to claim 2, in which the card of receiving spaces are arranged in columns.

4. An apparatus according to claim 3, in which the card receiving spaces are arranged in four columns, namely a first column, a second column, a third column and a fourth column.

5. An apparatus according to claim 4, in which the first column has exactly three card receiving spaces, the second column has exactly three card receiving spaces, the third column has exactly two card receiving spaces, and the fourth column has exactly two card receiving spaces.

6. An apparatus according to claim 1, in which the dealer area is defined by a plurality of card receiving spaces arranged in a single column.

7. An apparatus according to claim 6, in which the dealer area is defined by three card receiving spaces arranged in a single column.

8. An apparatus according to claims 6, in which the community area is defined by a plurality of card receiving spaces, wherein the card receiving spaces in the dealer area are aligned with the card receiving spaces in the community area.

9. An apparatus according to claim 1, in which the player area is defined by a plurality of card receiving spaces arranged in a single column.

10. An apparatus according to claim 9, in which the player area is defined by three card receiving spaces arranged in a single column.

11. An apparatus according to claims 9, in which the community area is defined by a plurality of card receiving spaces, wherein the card receiving spaces in the player area are aligned with the card receiving spaces in the community area.

12. An apparatus according to claim 1, in which the gaming table includes at least one player zone suitable for locating the player's cards and bets.

13. An apparatus according to claim 12, in which there are a plurality of player zones.

14. An apparatus according to claim 1, in which the gaming table has four sides, one of which is convexly curved and three of which are straight.

15. An apparatus according to claim 14, in which the gaming table includes at least one player zone suitable for locating the player's cards and bets, wherein the player zones are spaced around the convexly curved side of the gaming table.

16. An apparatus according to claim 1, in which the community, dealer and player areas are located substantially centrally on the gaming table.

17. A method of playing a card game including a plurality of playing cards and a gaming table, the gaming table including a dealer area, a community area, and a player area, the community area having ten card receiving spaces arranged according to two receiving spaces in a first row, four receiving spaces in a second row, and four receiving spaces in a third row such that a first and second column of the community area have three receiving spaces each and a third and fourth column of the community area have two receiving spaces each, the method including:
a) receiving a first bet from a player on a first player betting area of the gaming table;
b) dealing three cards to the player and three cards to the dealer, the three cards to the dealer being arranged in a single column in the dealer area;
c) dealing five cards face-up on the community area, the five cards being arranged in the three receiving spaces of the first column and the receiving spaces in the second and third rows of the second column;
d) optionally receiving a second bet from the player on a second player betting area of the gaming table;
e) dealing three cards face-up on the community area, the three cards being arranged in the receiving space in the first row of the second column and in the two receiving spaces of the third column
f) optionally receiving a third bet from the player on a third player betting area of the gaming table;
g) dealing two cards face-up on the community area, the two cards being arranged in the two receiving spaces of the fourth column;
h) placing the dealer's cards face-up on receiving spaces in the dealer area, the receiving spaces in the dealer area aligning with the three rows of the community area; and
i) placing the player's cards face-up on receiving spaces in the player area, the receiving spaces in the player area aligning with the three rows of the community area.

18. An apparatus including: at least one processor; and at least one memory including computer program code configured to, with the at least one processor, cause the apparatus at least to perform a method according to claim 17.

19. A computer program that, when run on a computer, performs a method according to claim 17.
